(19) United States
(12) Patent Application Publication
(10) Pub. No.: US 2018/0292202 A1
(43) Pub. Date: Oct. 11, 2018

(54) MARKING APPARATUS

(71) Applicant: Testo SE & Co. KGaA, Lenzkirch (DE)

(72) Inventors: Patrick Zahn, Titisee-Neustadt (DE); Stephan Kuppig, Titisee-Neustadt (DE)

(73) Assignee: Testo SE & Co. KGaA, Lenzkirch (DE)

(21) Appl. No.: 15/946,915

(22) Filed: Apr. 6, 2018

(30) Foreign Application Priority Data
Apr. 7, 2017 (DE) 102017107570.4

(51) Int. Cl. G01B 11/27; B25H 7/04; B44B 7/00

(52) U.S. Cl. CPC G01B 11/27; B44B 7/00; B25H 7/045

(57) ABSTRACT

A marking apparatus (1) having a presentation apparatus (9) for the optically guided alignment with a work site (5) on an object (3), wherein a digital model (2) of the object (3) is storable in a model memory and at least one mark (4) that corresponds to a work site (5) on the object (3) may be added to the digital model (2), wherein the location of the marking apparatus (1) with respect to the object (3) is determinable using a measuring apparatus.

### INCORPORATION BY REFERENCE

The following documents are incorporated herein by reference as if fully set forth: German Patent Application No. 10 2017 107 570.4, filed Apr. 7, 2017.

### BACKGROUND

The invention relates to a marking apparatus with which a work point or a work site, which may be a line or channel, can be displayed.

Known and common marking apparatuses are, for example, line lasers or cross line lasers. They project a horizontal and/or perpendicular line onto an area, such as a wall, so that a craftsman can easily orient himself using this line. Such a mark is helpful in particular when painting, laying tiles, cutting cable channels and performing similar activities.

It is a disadvantage here that the laser for projection must be placed at a location in the room in a spatially fixed manner. The laser may then be in the way during work or a projected line is at least partially obscured by a worker such that efficient work is no longer possible.

### SUMMARY

Is the object of the invention to provide a marking apparatus that makes possible improved marking of work sites and unimpeded work.

This object is achieved by a marking apparatus having one or more features of the invention.

The marking apparatus according to the invention in particular has a model memory for saving a digital model of an object, wherein at least one mark may be added to the model. It is thus possible for means for adding the mark to be provided. It furthermore has a measuring apparatus that is set up for determining a location of the marking apparatus with respect to the object, and a presentation apparatus that is set up for an optically guided alignment of the marking apparatus with a location on the object that corresponds to the mark stored in the model.

The digital model is for example a two-dimensional or three-dimensional representation of the object, for example a room or an entire building. The digital model thus comprises points, lines and/or geometric primitives that permit a presentation of the object.

In this model, marks may be added, for example points or lines, that correspond to the locations to be worked. Such a mark can be for example the position of a socket or a cable slot. It is possible here that these marks can be added within the marking apparatus or outside, in a separate model processing tool, in particular for example a 3D CAD program. Due to the addition to the model, the marks have a spatial relationship with the model.

The marking apparatus additionally has a measuring apparatus with which the location of the marking apparatus within the room is determinable. The marking apparatus is then alignable for example with respect to the model using the presentation apparatus.

That means that the presentation apparatus indicates when the marking apparatus in the room is directed at the mark.

The marking apparatus is embodied in particular as a processor driven portable device that a person carries around, for example. In this way, the marking apparatus does not need to be placed in the room and is therefore not in the way. In addition, the mark cannot be shaded by a person or object in the room. It can be in particular expedient if the marking apparatus is placeable for example on a drill, a wall chaser or another power tool.

The marking apparatus can have for example a laser that can image a point on an object. In this way, the mark on the object is more easy to identify.

The presentation apparatus can indicate here when the point of the laser is aligned with the position of the mark.

In a particularly advantageous embodiment, the presentation apparatus has a projection apparatus with which a mark is projectable onto the object in a locationally correct manner. In this way, it is possible to project not only for example a point, but the mark as a whole onto the object. For example a cross, a line or a point.

In a development of the invention, the presentation apparatus can have a projection apparatus with which a location reference is projectable onto the object. This location reference is preferably a large-area mark, for example a very large crosshair. This location reference makes it easier for the user to find the current position of the marking apparatus within the room and to align it with a mark to be worked. The location reference here always shows the current alignment on the object. In the case of a crosshair, the point of intersection of the two lines is situated exactly at the location with which the marking apparatus is currently aligned.

A particular embodiment of the invention makes provision for the marking apparatus to have a capture apparatus, with which the location reference is capturable and the alignment of the marking apparatus is determinable therefrom. The capture apparatus is preferably a separate device that is placed in a spatially fixed manner at a distance from the object. The difference or the deviation of this work point from the desired marked point can then be captured, and it is possible to indicate to the craftsman again how he must displace or pivot the tool in order to align the work direction with the desired marked point.

However, once again the problem arises here that the actual point of intersection of said crosshair cannot be capturable because a person or an object is situated in the field of view and shades the point of intersection.

The capture device can now capture the edges of the crosshair and extend them and in this way determine the point of intersection and therefore the alignment and recognize the location of the work point in or on the object.

In an alternative, expedient embodiment of the invention, the presentation apparatus has a display in which it is possible to present the mark and/or the marking apparatus in the model. In this way, it is possible to present not only the model, but also the mark within the model. In addition, it is possible to present the current position of the marking apparatus within the model. A craftsman or user can then very easily align the marking apparatus with a mark on the basis of the presentation.

In a particularly advantageous embodiment of the invention, the presentation apparatus has a display in which the mark is presentable in a locationally correct manner. The information from the measuring apparatus is here used to determine the location in order to produce a virtual image in which the mark is displayable in a locationally correct manner. In particular, the display can also be effected in a superposed real image of the object. To this end, the marking apparatus can have a camera, in whose image the mark can be injected in a locationally correct manner in the form of a superposition. The presentation apparatus can be a smartphone or tablet computer, for example. It is particularly advantageous, however, if the presentation apparatus is in the form of virtual smart glasses (virtual reality smart glasses), which makes it possible for the user to perceive the virtual presentation of the object as if it were real. Here, a superposed presentation in a real image would be particularly helpful for finding the orientation in virtual space. In addition to the superposition in a real image, the locationally correct injection on a see-through or transmissive area, in the manner of a head-up display, would also be possible.

It may furthermore be advantageous if the presentation apparatus has a display with which the direction in which the marking apparatus must be moved or pivoted to align it with the mark is displayable. The direction can be presentable here for example with an arrow. This directional indication can be implemented instead of or in addition to a presentation of the model.

Alternatively, the presentation apparatus can have four direction pointers which are arranged in the shape of a cross. These direction pointers can be, for example, simple light-emitting diodes, which are individually controllable. It is possible to realize such a display in a highly cost-effective and simple manner. It would therefore be possible to integrate this display in various tools, such as a drill. The drill could be, for example, connected to the marking apparatus via a radio link to receive direction instructions.

In an advantageous development of the invention, the marking apparatus has a camera for the image-type capturing of the object, and the presentation apparatus has a display in which it is possible to present the captured image of the object and/or information relating to the alignment of the marking apparatus and/or a mark. In this way, it is possible to present in the presentation apparatus not only a model, but also a real image of the object recorded with the camera.

In an expedient configuration of the invention, a selection device is present, with which the mark to be worked is selectable.

Such a selection device can be, for example, separate buttons with which a mark to be worked is selectable on the basis of the presentation apparatus. The selection device can also comprise a touch-sensitive screen (touchscreen).

In particular in the case of a plurality of marks which are added in the model, it is expedient if a display is present in which the selected mark is presented. In this way, it is easy to recognize which of the marks is currently active for work purposes.

The marking apparatus according to the invention can be embodied for example as a processor driven mobile hand-held device. Alternatively, it is possible to separately embody the presentation apparatus or even a direction display.

It is in particular advantageous if the marking apparatus is integrated in a tool for working or processing an object or is connectable thereto. The invention therefore also comprises a tool, in particular a drill, milling machine, cutting machine, machine saw or grinder, having a marking apparatus according to the invention, in particular wherein a work direction of the tool coincides with an alignment of the marking apparatus.

It would also be possible here for the marking apparatus to be embodied for example as a hand-held tool which, however, has no presentation apparatus. The presentation apparatus can in that case be embodied separately and be connected to the marking apparatus for example in contact-free fashion, in particular per radio. The presentation apparatus can then be integrated for example in a machining device or be attachable to a machining device as a separate device.

An alternative embodiment of the invention makes provision for the marking apparatus to have a stationary projecting apparatus which is positionable in a spatially fixed manner in a room or with respect to an object and is set up for projecting at least one mark, preferably all marks, onto the object.

In order to eliminate any arising shading due to an object or a person, the marking apparatus has a separate hand-held device having a further projector, with which the shaded image section is projectable in a supplementary fashion. In this way, the missing image content is supplemented by the projector of the hand-held device, with the result that overall, a complete image having all marks is always visible from the position of an observer.

The invention furthermore comprises a method for aligning a tool, wherein a mark is provided in a digital model of an object and a work step is performed with the tool by a user at a location on the object that corresponds to the mark, wherein an alignment of the tool with respect to the object is automatically ascertained and wherein the user is automatically instructed, on the basis of the ascertained alignment and the digital model, to align a work direction of the tool with the location on the object.

It is here in particular advantageous if the user is instructed by way of a mark which is projected onto the site in an automatically locationally correct manner.

In an advantageous embodiment of the method, the user is instructed to pivot the tool via automatically generated instructions.

### BRIEF DESCRIPTION OF THE DRAWINGS

The invention will be explained in more detail below with reference to an exemplary embodiment with reference to the attached drawings.

In the figures:

FIG. 1 shows a schematic view of a marking apparatus according to the invention for the locationally correct projection of a mark,

FIG. 2 shows a schematic view of a marking apparatus according to the invention having a presentation apparatus for displaying the model and the mark,

FIG. 3 shows a schematic view of a marking apparatus according to the invention having a presentation apparatus for displaying directional information,

FIG. 4 shows a schematic view of a marking apparatus according to the invention having a presentation apparatus with four direction arrows,

FIG. 5 shows a schematic view of the marking apparatus of FIG. 4 at different positions,

FIG. 6 shows a schematic view of a marking apparatus according to the invention for presenting a location reference and a separate capture apparatus,

FIG. 7 shows a schematic view of a marking apparatus with separate selection buttons for selecting the active marks,

FIG. 8 shows an alternative marking apparatus having an additional stationery projection apparatus, and

FIG. 9 shows a schematic view of a marking apparatus according to the invention having a presentation apparatus for the locationally correct display of the mark.

### DETAILED DESCRIPTION OF THE PREFERRED EMBODIMENTS

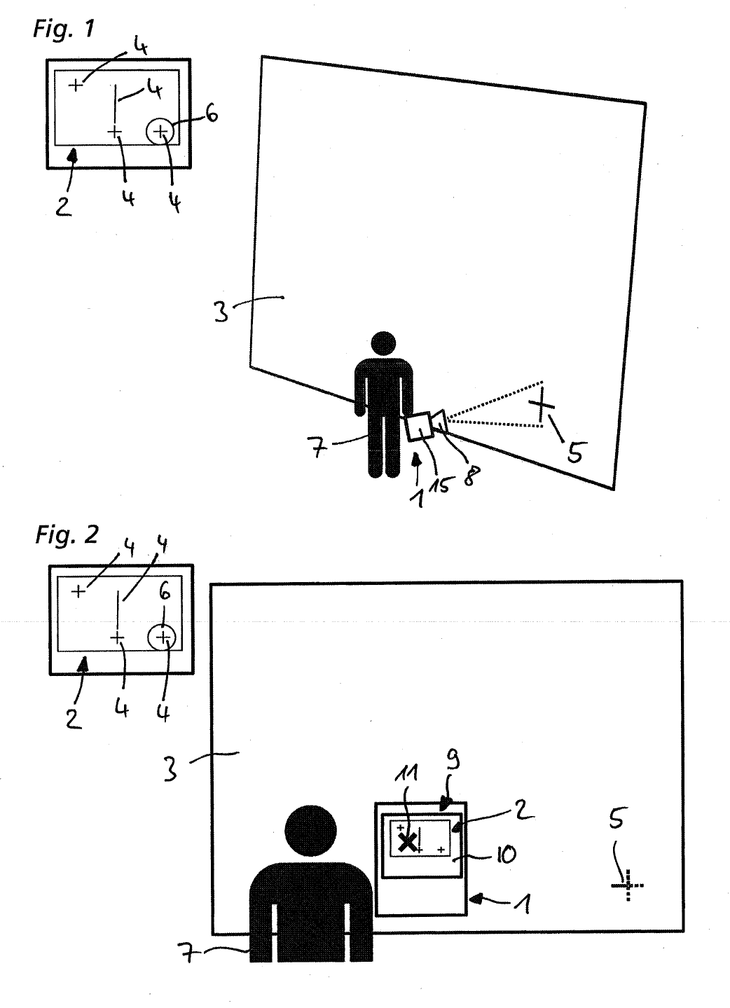

FIG. 1 shows a first embodiment of a marking apparatus 1 according to the invention. In the left half of the image, a schematic illustration of a digital model 2 of an object is presented. The object in this example is a wall 3 of a room. The model can be a two-dimensional model 2 of the wall 3 or a three-dimensional model of a room in which the wall is located. Added to the digital model 2 in the example are four marks 4, which each correspond to a work site 5 on the wall 3. Out of these, three work sites 5 are in the shape of a point and presented by way of a cross-shaped mark 4. One work site 5 is a line, which is also presented as such. The currently active mark 4 is encircled by a circle 6 for clarification.

This model 3 can have been created for example in a CAD program at a workstation. The marks 4 can also have been added to the model 2 there. Alternatively, the marking apparatus 1 can also have means for adding marks 4 to the model 2, for example by way of a touch-sensitive screen (touchscreen).

In the right half of the image, the wall 3 is depicted. Standing in front of the wall 3 is a person 7, for example a craftsman, who intends to drill holes at the work sites 5.

The person 7 is carrying a marking apparatus 1 according to the invention, which in this example is designed as a portable handheld device 15. The marking apparatus 1 has a projection apparatus 8, which is embodied such that a mark 4 can be projected onto the wall 3 in a locationally correct manner. As can be seen in the model 2, the mark 4 that is on the right is active. Accordingly, this mark 4 is projected onto the wall 3. The projection apparatus 8 can comprise for example a laser and a deflecting mirror, with which any desired pattern can be projected.

To determine the alignment, the marking apparatus 1 has a measuring apparatus that has for example one or more location sensors. It is particularly advantageous if the measuring apparatus has a plurality of acceleration sensors and at least one rate sensor.

FIG. 2 shows an alternative embodiment of the invention. Like in FIG. 1, the left half of the image here also shows the model 2 of the wall 3.

The marking apparatus 1 here has a presentation apparatus 9 having a display 10, in which the marks 4 and the marking apparatus 1 in the model 2 can be presented. In order to then align the marking apparatus 1 with a mark 4, all that is necessary is for the marking apparatus 1 to be moved until the presentation 11 of the marking apparatus 1 comes to lie congruently on the presentation of a mark 4. In addition, a projection apparatus may also be present in this embodiment of the marking apparatus 1 in order to project the mark 4, which has been manually aligned in this fashion, onto the object. Alternatively, the marking apparatus can also only have a simple laser pointer that projects a point in the work direction onto the object to optically indicate the work site after the alignment.

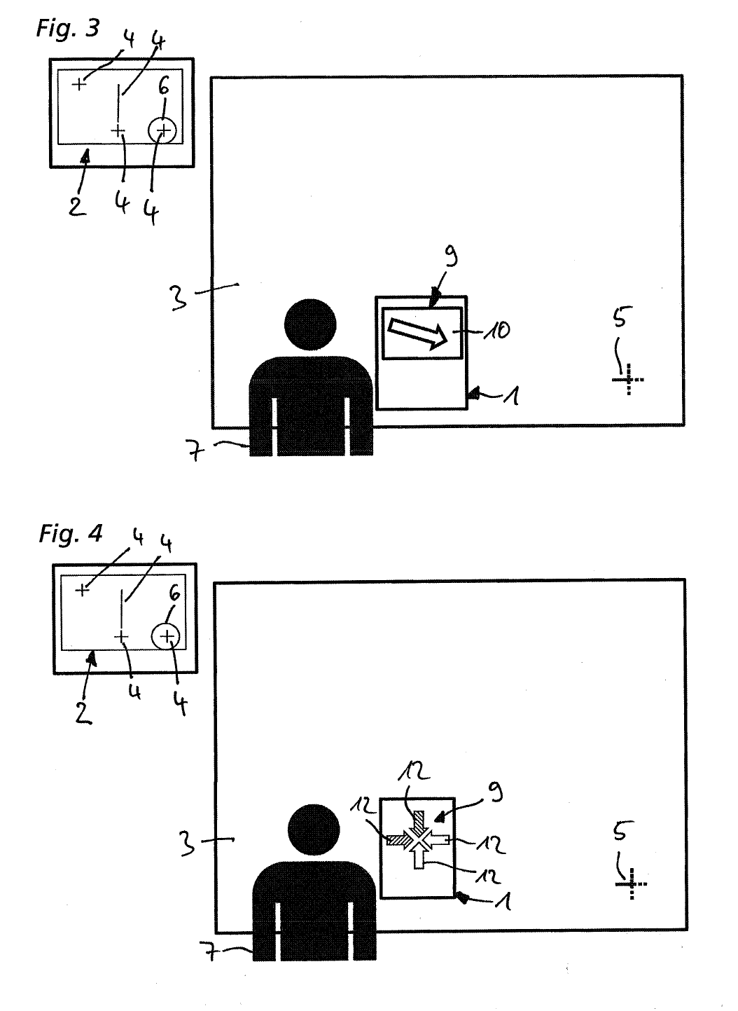

FIG. 3 shows a somewhat simpler embodiment of a marking apparatus 1 according to the invention. This embodiment also has a presentation apparatus 9 having a display 10. However, the display is here only able to display a direction arrow 12, which points in the direction in which the marking apparatus 1 must be pivoted to align it with the mark 4 to be worked, i.e. the active mark. The display 10 can here be a simple monochromatic LC display or an LED dot matrix display. The display can also be formed from a plurality of light-emitting displays, e.g. LEDs, that are arranged in a circle. In this way, the display is substantially more cost-effective and easier to produce.

An even simpler and more cost-effective embodiment of the invention is shown in FIG. 4. Here, the presentation apparatus 9 has four separate optical displays that are embodied in the example as arrow-shaped LEDs 12. The arrow LEDs 12 are oriented in each case in the four main directions. Using these arrow LEDs 12, again that direction is displayed in which the marking apparatus 1 must be pivoted so as to be aligned with the active mark 4. This display 10 having four separate arrow LEDs 12 is particularly simple to produce. The display 10 can also be arranged for example separately from the marking apparatus 1, for example in the handle of a power tool, such as a drill. In this way, the location to be worked can be found directly with the tool without the need to first take the marking apparatus in the hand. The connection between display and marking apparatus can here be carried out, for example, in contact-free fashion using a radio link.

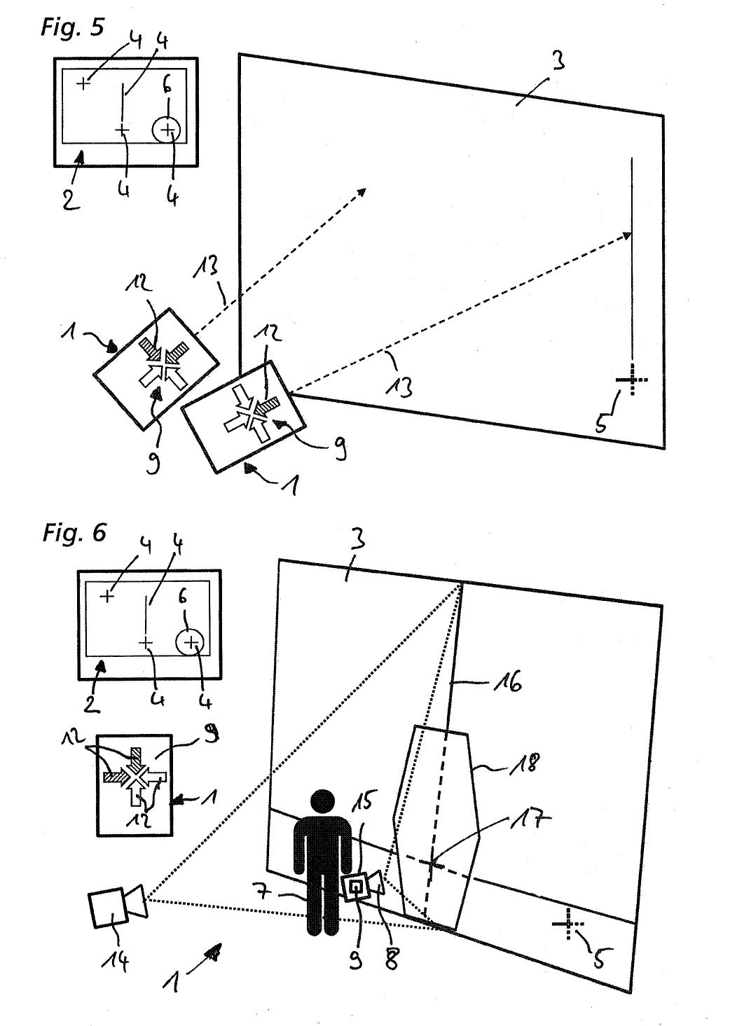

FIG. 5 shows the marking apparatus 1 of FIG. 4 by way of example in two different alignments. On the left in the image, the marking apparatus 1 is aligned with an arbitrary location on the wall, as is indicated by the direction arrow 13. The active mark 4 is located at the bottom right on the wall 3, as is indicated in the model 2 at the top on the left by way of the circle 6. Starting with this alignment, the marking apparatus 1 would therefore have to be pivoted to the right and down to be aligned with the work site 5. For this reason, the two arrow LEDs 12 which point down and to the right light up in the display 10, indicated by hatched lines. The second marking apparatus 1 in the image has already been pivoted to the right so far that it is aligned with a perpendicular line 14 running through the work site 5, as is also indicated here by a direction arrow 13′. The marking apparatus 1 therefore only needs to be pivoted down now. Therefore, only the arrow LED 12 that points down is still lit in the display 10. As soon as the marking apparatus 1 is aligned with the work site 5, all arrow LEDs 12 can be switched off or on.

FIG. 6 shows an alternative embodiment of the invention, in which the marking apparatus 1′ consists of a stationary capture apparatus 14 and a hand-held device 15. The hand-held device 15 has a projector 8 that projects a location reference onto the wall 3, a large crosshair in the example. The point of intersection 17 of the crosshair 16 is here automatically always at the location with which the hand-held device 15 is currently aligned.

The crosshair 16 is capturable with the capture apparatus 14, and the alignment of the hand-held device 15 is determinable therefrom. Any shading 18 that may appear due to a person 7 can be compensated for by the capture apparatus 14 by way of extending the cut-off lines of the crosshair 16 to the point of intersection 17. On the basis of the alignment of the hand-held device 15, which has been ascertained in this way, a manual alignment with the active work site 5 can be performed using a presentation apparatus 9, for example having four arrow LEDs 12.

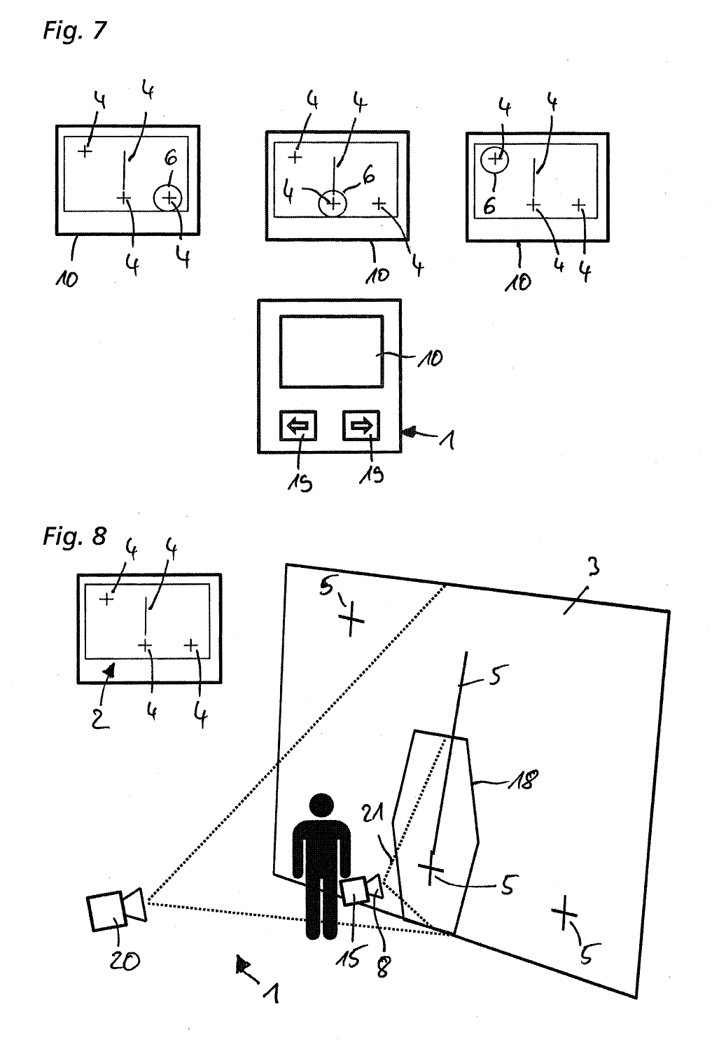

FIG. 7 shows by way of example a presentation apparatus 9 of a marking apparatus 1 according to the invention. The display 10 is here embodied for presenting the digital model 2 with the added marks 4. The presentation apparatus 9 here has two buttons 19, via which the respectively active mark 4 is selectable. In the display 10 at the very left, for example the mark 4 that is on the right is active, as is indicated by the circle 6. By pressing the left-hand button 19, the circle 6 of the active mark can be displaced to the left, as is illustrated by the two presentations of the display 10 which are located next to one another.

Rather than the buttons 19, the display 10 can also be in the form of a touchscreen for example, such that the active mark 4 is settable directly via a selection on the display 10.

FIG. 8 shows an alternative embodiment of the marking apparatus 1 according to the invention. The marking apparatus 1 here has a hand-held device 15, which substantially corresponds to FIG. 4. In addition, the marking apparatus 1 has a second, stationary projection apparatus 20, which projects all marks 4 in the model 2 onto the wall 3. Any shading 18 of a mark 4 that may appear, for example due to the person 7, is eliminated by a supplementing projection 21 of the shaded region 12 by the projection apparatus 8 of the hand-held device 15.

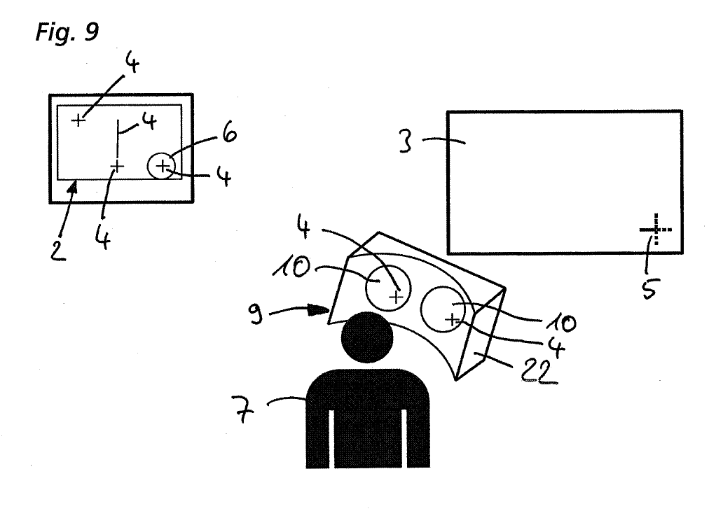

FIG. 9 shows a schematic view of a marking apparatus 1 according to the invention having a presentation apparatus 9 for the locationally correct display of a mark 4. The presentation apparatus 9 here has the form of smartglasses 22, or virtual reality (VR) glasses. These glasses 22 are known in various embodiments. Also available nowadays are holders in which a conventional smartphone can be placed. The presentation apparatus 9 has a measuring apparatus for determining the location within the room or at least with respect to the object, here a wall 3, on which the mark is to be provided. The presentation apparatus 9 furthermore has two displays 10 in which the mark 4 is presentable in a locationally correct fashion on the basis of the location information. Two displays 10 are necessary for the spatial presentation. However, only one display which is split into two regions by a mask can also be provided. Locationally correct here means that the mark 4 is presented in the display 10 as a person 7 would see it if it were provided directly on the object 3 at the work site 5.

The invention describes a marking apparatus 1 having a presentation apparatus 9 for the optically guided alignment with a work site 5 on an object 3, wherein a digital model 2 of the object 3 is storable in a model memory and at least one mark 4 that corresponds to a work site 5 on the object 3 may be added to the digital model 2, wherein the location of the marking apparatus 1 with respect to the object 3 is determinable using a measuring apparatus.

### LIST OF REFERENCE SIGNS

1 Marking apparatus
2 Digital model
3 Wall
4 Mark
5 Work site
6 Circle
7 Person
8 Projection device
9 Presentation apparatus
10 Display
11 Presentation of the marking apparatus
12 Arrow LED
13 Direction arrow
14 Capture apparatus
15 Hand-held device
16 Crosshair
17 Point of intersection
18 Shading
19 Button
20 Stationary projection apparatus
21 Supplementing projection
22 Smartglasses

1. A marking apparatus (1) comprising
a processor connected to a model memory for storing a digital model (2) of an object (3), configured such that at least one mark (4) is addable to the model (2),
a measuring apparatus configured to determine a location of the marking apparatus (1) with respect to the object (3), and
a presentation apparatus (9) that is set up for an optically guided alignment of the marking apparatus (1) with a location (5) on the object (3) that corresponds to the mark (4) which is stored in the model.

2. The marking apparatus (1) as claimed in claim 1, wherein the presentation apparatus (1) has a projector (8), with which a mark (4) is projectable onto the object (3) in a locationally correct manner.

3. The marking apparatus (1) as claimed in claim 1, wherein the presentation apparatus (9) has a projector (8), with which a location reference (16) is projectable onto the object (3).

4. The marking apparatus (1) as claimed in claim 1, further comprising a capture apparatus (14) configured to capture a location reference (16), and the alignment of the marking apparatus (1) is determinable therefrom.

5. The marking apparatus (1) as claimed in claim 1, wherein the presentation apparatus has a display in which at least one of the mark or the marking apparatus in the model is presented.

6. The marking apparatus (1) as claimed in claim 1, wherein the presentation apparatus (9) comprises a display (10) in which the mark (4) is presentable in a locationally correct manner.

7. The marking apparatus (1) as claimed in claim 6, wherein the marke is presented as a superposed real image.

8. The marking apparatus (1) as claimed in claim 1, wherein the presentation apparatus (9) has a display (10) with which a direction in which the marking apparatus (1) must be moved or pivoted to align it with the mark is displayable.

9. The marking apparatus (1) as claimed in claim 1, wherein the presentation apparatus (9) has four direction pointers (12) arranged in a cross shape.

10. The marking apparatus (1) as claimed in claim 1, wherein the marking apparatus (1) includes a camera for the image capturing of the object (3), and the presentation apparatus (9) has a display (10) in which at least one of the captured image of the object, information relating to the alignment of the marking apparatus (1), or a mark (4) is displayed.

11. The marking apparatus (1) as claimed in claim 1, further comprising a selection device (19) with which the mark (4) to be worked is selectable.

12. The marking apparatus (1) as claimed in claim 1, further comprising a display (10) in which the selected mark (4) is presented.

13. A tool for working on or machining an object, in particular a drill, milling machine, cutting machine, machine saw or grinder, having a marking apparatus as claimed in one of the preceding claims, in particular wherein a work direction of the tool coincides with an alignment of the marking apparatus.

14. A method for aligning a tool, comprising:
providing a mark (4) in a digital model (2) of an object (3),
performing a work step with the tool by a user (7) at a location (5) on the object (3) that corresponds to the mark (4),
automatically ascertaining an alignment of the tool with respect to the object (3), and
automatically instructing the user (7) based on the ascertained alignment and the digital model (2), to align a work direction of the tool with the location (5) on the object (3).

15. The method as claimed in claim 14, further comprising instructing the user (7) using the mark (4) that is projected onto the location (5) in an automatically locationally correct manner.

16. The method as claimed in claim 12, further comprising instructing the user (7) with automatically generated instructions to pivot the tool.
